(19) United States
(12) Patent Application Publication
(10) Pub. No.: US 2015/0292679 A1
(43) Pub. Date: Oct. 15, 2015

(54) Method for Producing a Tank, in Particular a Motor Vehicle Tank

(71) Applicant: Bayerische Motoren Werke Aktiengesellschaft, Muenchen (DE)

(72) Inventor: Lorenz EHGARTNER, Garching (DE)

(21) Appl. No.: 14/684,890

(22) Filed: Apr. 13, 2015

(30) Foreign Application Priority Data
Apr. 11, 2014 (DE) 10 2014 207 069.4

(51) Int. Cl. F17C 1/16

(52) U.S. Cl. CPC F17C 1/16; F17C 2209/2127; F17C 2209/228; F17C 2209/234; F17C 2205/0305

(57) ABSTRACT

A connection element is provided for a pressure tank. The connection element is to be introduced into an opening of the pressure tank. The connection element includes a stopper element and a counterelement at least partially enclosing the stopper element. An outer side of the stopper element and an inner side of the counterelement form a tapering clearance, with the result that a tank wall of the pressure tank can be clamped in the clearance of the connection element.

### CROSS REFERENCE TO RELATED APPLICATION

This application claims priority under 35 U.S.C. §119 from German Patent Application No. 10 2014 207 069.4, filed Apr. 11, 2014, the entire disclosure of which is herein expressly incorporated by reference.

### BACKGROUND AND SUMMARY OF THE INVENTION

The present invention relates to a connection element for a pressure tank. Furthermore, the invention relates to a pressure tank which includes such a connection element. The pressure tank is, in particular, a cryogenic pressure tank or a high-pressure tank, the pressure tank advantageously being able to be used to store hydrogen. The pressure tank is advantageously provided for use in a motor vehicle.

Tanks which can in particular be used to store hydrogen are known from the prior art. In order to prevent metal embrittlement which usually occurs when hydrogen is stored in a metal tank, hydrogen tanks are frequently produced from plastic. A connection element via which the tank can be closed can be introduced into such a plastic tank, the connection element also being intended to allow filling and emptying of the tank. Such connection elements are usually produced from metal. Therefore, a combination of plastic tank and metal closure is necessary.

Such an arrangement is disclosed, for example, in DE 2 152 123 A1. This document shows a pressure container whose opening merges continuously into a hollow-cylinder-shaped neck. The hollow-cylinder-shaped neck is enclosed by a likewise hollow-cylinder-shaped pole piece, the neck of the pressure container and the pole piece being conically widened outwardly. Finally, a gas-tight valve can be mounted on the pole piece. However, this has the disadvantage that the plastic wall of the plastic tank must have a cone shape.

DE 19 631 546 C1 discloses a composite pressure container. This container includes a plastic tank and a winding of a fiber composite material for strengthening the plastic tank (liner). A neck piece is introduced into the liner and fixed to the liner with a clamping ring. However, it is disadvantageous here that the clamping ring is screwed into the neck piece in an internally flush manner, thereby making it more difficult to screw in a tank valve.

DE 10 2009 014 057 A1 discloses a pressure container for storing gaseous media. The pressure container has a wall of fiber composite material, a plastic tank and a connection flange with a supporting ring. In this arrangement, however, an additional spring element is required, making the required installation very complicated.

Furthermore, WO 06 034 439 A2 discloses a tank which includes a valve body together with O-ring seal, a metal ring and a plastic tank. A resilient clamping element is additionally used to press the plastic tank (liner) onto the metal ring and to seal the liner with respect to the metal ring. In this arrangement, however, a thread is located in the liner and can be destroyed under excessive mechanical loading. Moreover, this thread makes it more difficult and more expensive to produce the plastic liner.

In addition, DE 10 2010 023 386 A1 discloses a pressure container for storing liquid or gaseous media. The basic body of this pressure container consists of a plastic with a rotationally symmetrical collar into which a portion of a pressure valve is inserted. A connection piece of metal is located outside the collar. Here, the pressure valve is provided with an external thread which is screwed into the end of the connection piece that is directed away from the basic body. The basic body and the flange are at least partially enclosed by a protective sleeve of fiber composite material.

DE 10 2010 049 838 A1 discloses a pressure container for storing a fluid, which has a plastic liner. The plastic liner includes a plurality of parts produced independently of one another. However, the multi-part construction of the plastic liner makes it considerably more difficult to assemble the pressure tank.

Finally, DE 10 2009 049 948 B4 discloses a pressure container which is suitable for storing liquid and gaseous media. The pressure container includes a plastic inner container with at least one neck piece. This neck piece is provided with means for receiving a connection fitting. The pressure container includes an insert which forms at least part of the container neck and thus a seal between the neck piece and the fitting which is to be inserted. However, this is not stable after installation, which means that, for stabilization purposes, the tank valve must be enclosed with fiber composite material and adhesive. It is only then that the tank valve and thus the pressure tank is sealed with respect to the liquid or gaseous stored media.

It is an object of the invention to provide a connection element for a pressure tank which allows secure and reliable sealing of the pressure tank while being simple and cost-effective to produce. It is also an object of the invention to provide a corresponding pressure tank.

This and other objects are achieved by a connection element for a pressure tank which can be inserted into an opening of the pressure tank. The connection element includes a stopper element and a counterelement which can be connected to the stopper element. Provision is made here for the counterelement to at least partially enclose the stopper element. Here, an outer surface of the stopper element and an inner surface of the counterelement form a tapering clearance. A tank wall of the pressure tank can be inserted in this clearance. The tapering clearance advantageously makes it possible for the tank wall to be pressed between the stopper element and counterelement, with the result that the tank wall can be clamped into the clearance. Here, the tank wall is advantageously clamped by introducing the stopper element into the counterelement.

Provision is advantageously made for the counterelement to be a metal cone and/or a metal insert part with a conical surface. The tapering clearance is formed by the cone shape. Thus, the tank wall can be pressed by the conical surface and/or the metal cone against the stopper element.

In one preferred embodiment, the stopper element is designed in such a way that it has at least, in part, a conical surface. Once again, the tapering clearance is formed by the conical surface. It is particularly preferred for both the stopper element and the counterelement to be configured with a conical surface, with the result that the tapering clearance is formed, as it were, by the counterelement and stopper element. The provision of the conical surface of the stopper element and/or counterelement also preferably makes it possible to set a degree of the clamping of the tank wall. Therefore, provision is advantageously made for the stopper element and the counterelement to be able to be positioned displaceably with respect to one another when they are connected.

Provision is also preferably made for the stopper element to have at least one external thread. In a first advantageous alternative, the counterelement is screwed onto the at least one external thread. Thus, the counterelement is connected to the stopper element, it being possible for the counterelement and stopper element to be positioned relative to one another. Alternatively or in addition, a screwing nut is provided as a second advantageous alternative. The screwing nut is advantageously operatively connected to the counterelement, with the result that a screwing-in and/or unscrewing of the screwing nut displaces the counterelement relative to the stopper element. The counterelement can also thus be positioned relative to the stopper element. In the second alternative, provision is advantageously made for the counterelement not to have its own thread by which the counterelement can be screwed onto the external thread of the stopper element. Consequently, the counterelement can be produced very simply and cost-effectively.

The stopper element advantageously has a recess, it being possible for the tank wall to be pressed into the recess of the stopper element by the counterelement. In particular, an end region of the tank wall can be pressed into the recess. Moreover, provision is preferably made for the recess to be incorporated at such a point of the tapering clearance at which the tapering clearance has a minimum dimension. It is consequently possible to achieve a maximum clamping effect in this region, with the result that the tank wall can be fixed within the recess.

Furthermore, provision is preferably made for the stopper element to have a sleeve shape. Should the stopper element, as described above, have at least one external thread, this thread is thus arranged on an outer surface of the sleeve-shaped stopper element. It is particularly preferred for the sleeve-shaped stopper element additionally to be provided with an internal thread, with the result that further components can be screwed into the stopper element. A closure valve for the pressure tank can be screwed particularly advantageously into such an internal thread. Thus, the connection element advantageously serves for closing the pressure tank, for emptying the pressure tank, and/or for filling the pressure tank.

In addition, the counterelement advantageously has an annular shape. Provision is particularly preferably made here for the annular shape to surround the above-described sleeve shape of the stopper element.

Finally, provision is preferably made for the counterelement to be surrounded by a fiber wrapping. The fiber wrapping allows the counterelement, and thus the connection element, to be securely and reliably fixed within the opening of the pressure tank.

The invention also relates to a pressure tank. The pressure tank has a tank wall. The tank wall has an opening. A connection element as described above is inserted into the opening. The pressure tank is advantageously a cryogenic pressure tank or a high-pressure tank, in particular for at least 600 bar. The pressure tank can preferably be filled with a combustible gas, advantageously hydrogen. Provision is also preferably made for the pressure tank to be provided for use in a motor vehicle.

The tank wall of the pressure tank is advantageously produced from a plastic. Provision is particularly made for the tank wall to be produced from a plastic by extrusion blow molding. This allows the pressure tank to be produced as a one-piece element. A complicated assembly of individual components of the pressure tank is thus not necessary. All that is required is for a connection element as described above to be inserted into the extrusion-blow-molded plastic element, which thus forms the tank wall.

The connection element is preferably inserted into the opening of the tank wall by screwing a thread of the stopper element into the tank wall. Provision is preferably made here for a counterthread of the tank wall to be cut by the thread of the stopper element itself. Thus, advantageously, no counterthread has to be produced in the tank wall itself. This in turn simplifies the production of the tank wall.

As an alternative, provision is made for the stopper element to be pressed into the opening of the tank wall. In this case, production of the pressure tank is very simple since, after producing the tank wall, the stopper element is merely pressed into an opening of the tank wall. The clamping according to the invention of the tank wall between the stopper element and the counterelement of the connection element ensures secure and reliable retention.

It is advantageously provided for the pressure tank that no demands are placed on the construction of the tank wall. Thus, the pressure tank can have any desired shape without the leaktightness of the connection element being compromised. Leaktightness is reliably ensured by the clamping of the tank wall between the counterelement and stopper element.

Furthermore, provision is made for the connection element to be arranged in the pressure tank in an externally flush manner. This makes it possible for a tank valve to be able to be screwed into the connection element in an unimpeded manner.

The pressure tank is completely sealed, in particular, by the insertion of the connection element and the resulting clamping of the tank wall between the counterelement and stopper element. However, provision is advantageously made for an additional adhesive and/or fiber composite material to surround the tank wall in order further to increase stability and sealing.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic diagram of the connection element according to a first exemplary embodiment of the invention;

FIG. 2 is a schematic diagram of the connection element according to a second exemplary embodiment of the invention;

FIG. 3 is a schematic diagram of the connection element according to a third exemplary embodiment of the invention;

FIG. 4 is a schematic diagram of the connection element according to a fourth exemplary embodiment of the invention;

FIG. 5 is a schematic illustration of a pressure tank according to an embodiment of the invention with a connection element according to the fourth exemplary embodiment of the invention;

FIG. 6 is a detail view of FIG. 5; and

FIG. 7 is a schematic view of a pressure tank according to an embodiment of the invention with a connection element according to the third exemplary embodiment of the invention.

### DETAILED DESCRIPTION OF THE DRAWINGS

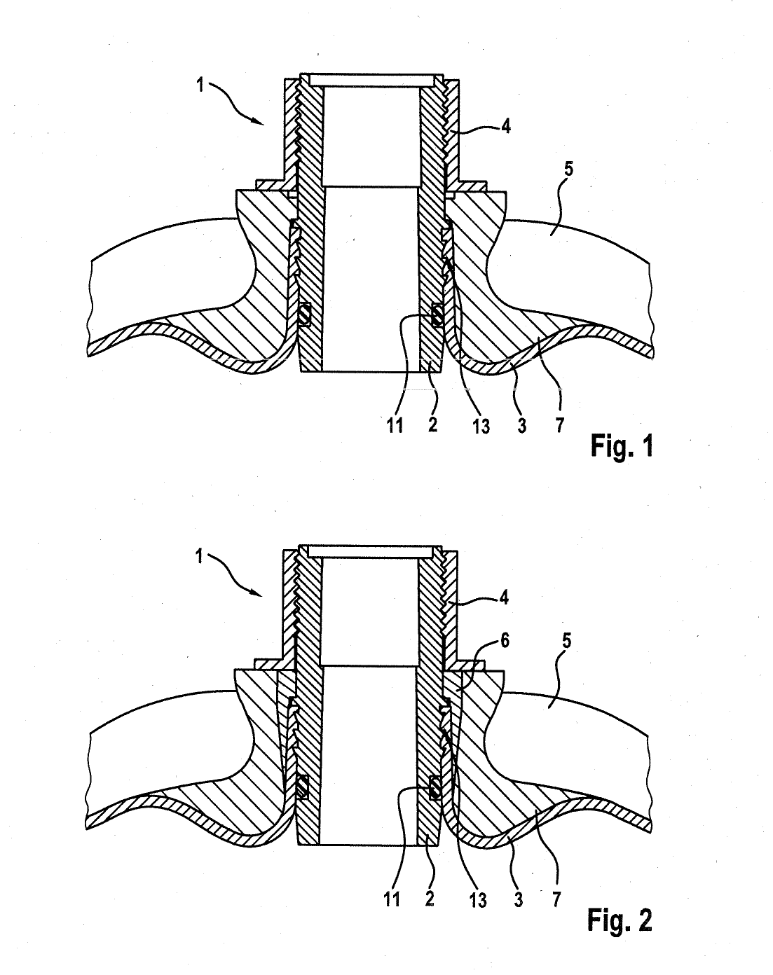

FIG. 1 shows a connection element 1 which is inserted into an opening of a tank wall 3 of a pressure tank. The connection element 1 includes a stopper element 2 which is inserted into the opening of the tank wall 3. The stopper element 2 is sealed with respect to the tank wall 3 via an O-ring 11.

The stopper element 2 is advantageously inserted into the tank wall 3 in two different ways: on the one hand, the stopper element 2 can be pressed into the opening of the tank wall 3 and, on the other hand, provision is made for the stopper element 2 to have a first thread by which the stopper element 2 can be screwed into the opening of the tank wall 3. Provision is made in particular here for the tank wall 3 not to have a counterthread, but for the counterthread to be cut into the tank wall 3 by the first thread of the stopper element 2.

To improve sealing between the tank wall 3 and stopper element 2, a counterelement is provided. In FIG. 1, the counterelement is a metal insert part 7. The metal insert part 7 extends around the stopper element 2 and can be fixed by a screwing nut 4. Provision is made here for the metal insert part 7 and stopper element 2 to have a conical surface, with the result that a tapering clearance 13 between an inner side of the metal insert part 7 and the outer side of the stopper element 2 is obtained. Thus, as the screwing nut 4 is increasingly screwed in, the metal insert part 7 is pressed onto the tank wall 3 in such a way that the tank wall 3 is clamped between the metal insert part 7 and stopper element 2. As an alternative to the separate screwing nut 4, provision is also made for the screwing nut 4 to be formed in one piece with the metal insert part 7.

To increase the stability and leaktightness of the connection, a fiber wrapping 5 is, in particular, also provided around the tank wall 3. However, this is merely an optional aid since leaktightness is already ensured by the tank wall 3 being clamped between the metal insert part 7 and stopper element 2.

FIG. 2 shows a second exemplary embodiment of the connection element 1 according to the invention. Here, elements which are identical or similar to those in FIG. 1 are provided with the same reference signs.

By contrast with FIG. 1, the second exemplary embodiment has a metal cone 6. Provision is made here for the screwing nut 4 to press the metal cone 6, in an analogous manner to the metal insert part 7 from FIG. 1, against the tank wall 3, with the result that the tank wall 3 is clamped in a tapering clearance 13 between the metal cone 6 and stopper element 2. Thus, the metal cone 6 corresponds to the counterelement. In order to fix the metal cone 6, the metal insert part 7 is furthermore provided, the metal cone 6 being provided between the tank wall 3 and metal insert part 7.

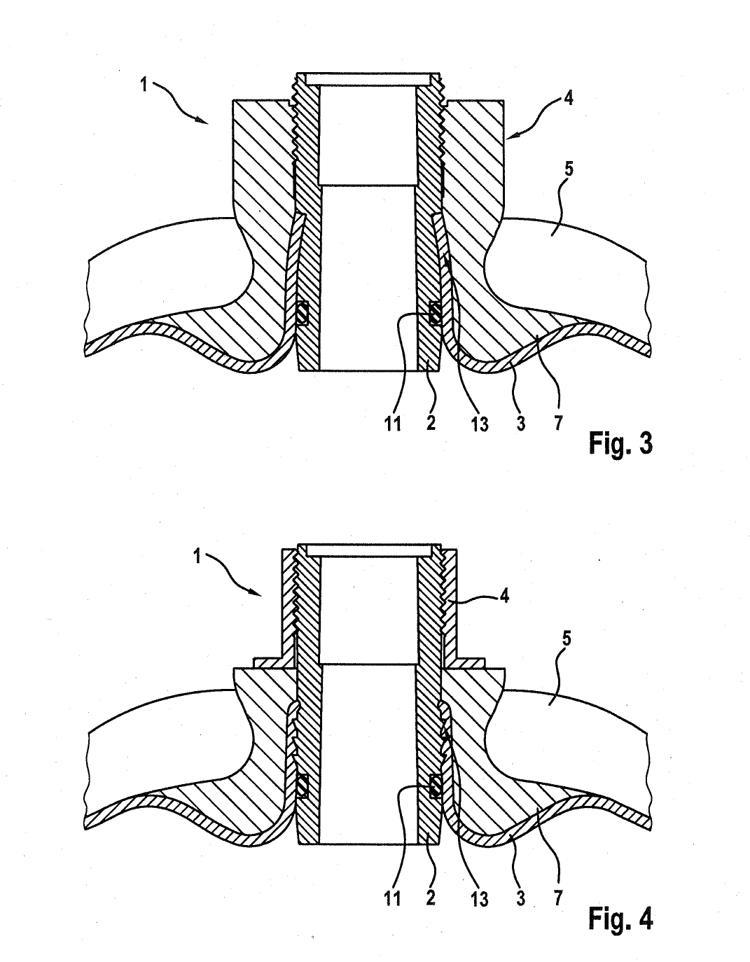

A third exemplary embodiment of the connection element is shown in FIG. 3. Once again, the same reference signs indicate that parts which are identical or similar to those in the aforementioned exemplary embodiments are concerned. In the third exemplary embodiment there is provided a clamping region 12 in which the tank wall 3 can be clamped. Provision is made here for the metal insert part 7 and the stopper element 2 to have a conical surface, and thus the tapering clearance 13, only in one region, namely the clamping region 12. Thus, the outer wall 3 is clamped only in the clamping region 12. Moreover, in the third exemplary embodiment, the screwing nut 4 is formed in one piece with the metal insert part 7.

Finally, a fourth exemplary embodiment of the connection element 1 is shown in FIG. 4. In the fourth exemplary embodiment, identical or similar elements are again designated with the same reference signs as in the preceding exemplary embodiments. It can be seen in FIG. 4 that the stopper element 2 has a recess 9 in addition to the conical surface forming the tapering clearance 13. Thus, the tank wall 3 is pressed into the recess 9, resulting in additional fixing and sealing.

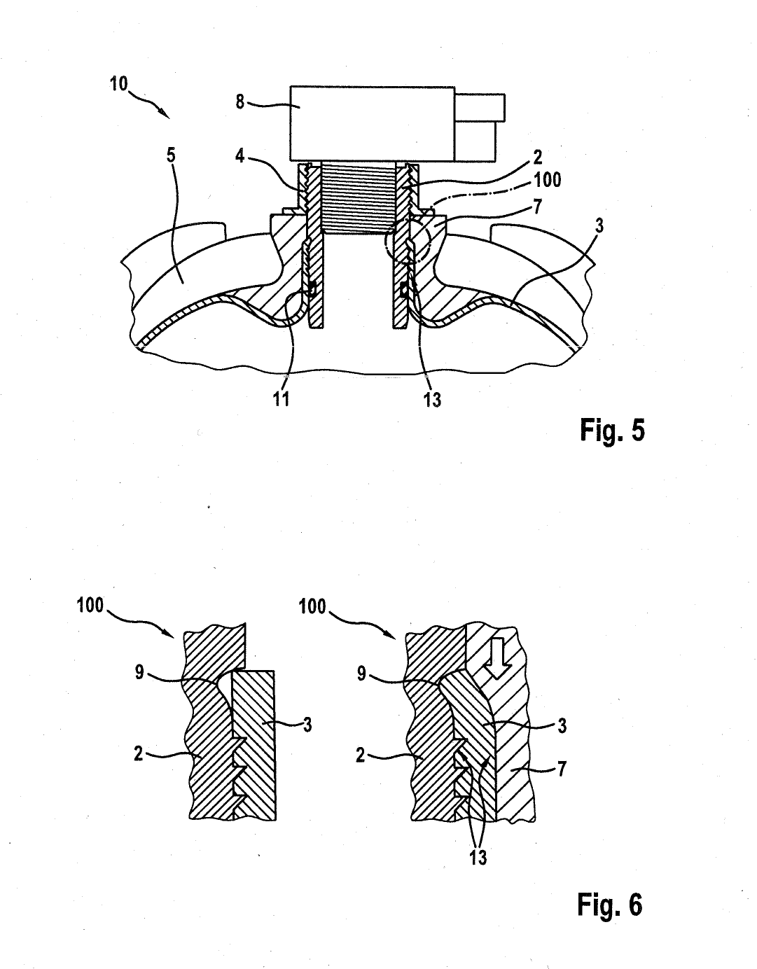

Finally, FIG. 5 shows a pressure tank 10 according to an embodiment of the invention. The pressure tank 10 is, in particular, a high-pressure tank. The high-pressure tank can advantageously be used to accommodate fluids, gases or liquids under a maximum pressure of at least 600 bar. The pressure tank 10 can particularly preferably be used for accommodating fuels for an engine or a fuel cell, in particular for accommodating hydrogen or natural gas. The pressure tank 10 includes the connection element 1 according to the fourth exemplary embodiment from FIG. 4.

It can be seen from FIG. 5 that the stopper element 2 has a sleeve shape. Thus, in addition to an external thread onto which the screwing nut 4 is screwed, an internal thread into which a tank valve 8 can be screwed is, in particular, also provided. The internal thread thus serves for connecting the connection element 1, and thus the pressure tank 10, to further components. Thus, the pressure tank 10 is particularly suitable for use in a motor vehicle since the connection element 1 can be connected to a supply line for a combustion engine of the motor vehicle. To increase the stability of the pressure tank 10, the tank wall 3 is provided with a fiber wrapping 5.

FIG. 6 shows two different views of a detail region 100 from FIG. 5. The detail region 100 shows how the tank wall 3 can be pressed into the recess 9 of the stopper element 2. By applying the metal insert part 7 by the screwing nut 4, the tank wall 3 is, on the one hand, clamped in by the conical surfaces of the stopper element 2 and metal insert part 7. In addition, the tank wall 3 is pressed by the metal insert part 7 into the recess 9 of the stopper element 2. Thus, secure and reliable connection and sealing is provided.

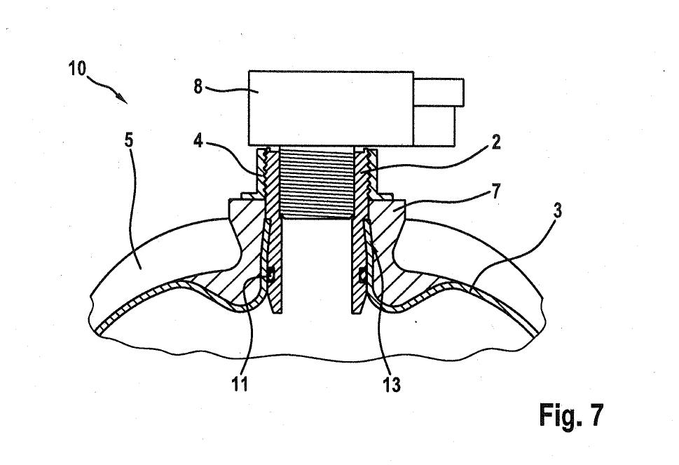

FIG. 7 shows a pressure tank according to an embodiment of the invention, identical or similar elements again being represented by the same reference signs as in the preceding exemplary embodiments. The exemplary embodiment of the pressure tank 10 shown in FIG. 7 shows a tank wall 3 into which the connection element 1 according to the third exemplary embodiment from FIG. 3 is inserted. Once again, provision is preferably made for the tank wall 3 to be provided with a fiber wrapping 5 so as to ensure stability of the pressure tank 10.

The pressure tank 10 is advantageously used in a vehicle. The vehicle is advantageously a motor vehicle, in particular a passenger motor vehicle. Since the pressure tank 10 can be produced very simply and cost-effectively, only very low costs and very little effort are necessary to provide the pressure tank 10 in the vehicle.

### LIST OF REFERENCE SIGNS

1 Connection element
2 Stopper element
3 Tank wall
4 Screwing nut
5 Fiber wrapping
6 Metal cone
7 Metal insert part
8 Tank valve
9 Recess
10 Pressure tank
11 O-ring
12 Clamping region
13 Tapering clearance

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1-16. (canceled)

17. A connection element for a pressure tank having an opening, the connection element comprising:
a stopper element;
a counter element configured to at least partially enclose the stopper element, wherein:
the stopper element is configured to be introduced into the opening of the pressure tank, and has an outer side that forms a tapering clearance with an inner side of the counter element, and
the tapering clearance is designed to receive a tank wall of the pressure tank to be clamped in the tapering clearance.

18. The connection element according to claim 17, wherein
the counter element comprises a metal cone with a conical surface to form the tapering clearance.

19. The connection element according to claim 17, wherein
the counter element comprises a metal insert part with a conical surface to form the tapering clearance.

20. The connection element according to claim 18, wherein
the stopper element has at least, in part, a conical surface to form the tapering clearance.

21. The connection element according to claim 19, wherein
the stopper element has at least, in part, a conical surface to form the tapering clearance.

22. The connection element according to claim 17, further comprising:
a screwing nut, wherein
the stopper element has at least one external thread, and
the screwing nut is operatively connected to the counter element, and is screwed onto the external thread of the stopper element.

23. The connection element according to claim 17, wherein
the stopper element has an external thread, and
the counter element is screwed onto the external thread of the stopper element.

24. The connection element according to claim 17, wherein
the stopper element has a recess on the outer side,
the counter element is configured to press an end region of the tank wall into the recess when the stopper element is introduced into the opening of the pressure tank.

25. The connection element according to claim 17, wherein the stopper element has a sleeve shape.

26. The connection element according to claim 25, wherein the counter element has an annular shape.

27. The connection element according to claim 17, further comprising a fiber wrapping that surrounds the counter element.

28. A pressure tank, comprising:
a tank wall having an opening;
a connection element arranged in the opening of the tank wall, wherein the connection element comprises:
a stopper element;
a counter element configured to at least partially enclose the stopper element, wherein:
the stopper element is introduced into the opening of the pressure tank, and has an outer side that forms a tapering clearance with an inner side of the counter element, and
the tapering clearance is designed to receive the tank wall of the pressure tank to be clamped in the tapering clearance.

29. The pressure tank according to claim 28, wherein the tank wall is made of a plastic.

30. The pressure tank according to claim 29, wherein the tank wall is an extrusion blow molded tank wall.

31. The pressure tank according to claim 28, wherein
the stopper element of the connection element has an external thread on the outer side, and
a counter thread is formed in the tank wall via the external thread of the stopper element when the stopper element is introduced into the opening of the pressure tank.

32. The pressure tank according to claim 28, wherein the stopper element is configured to be pressed into the opening of the tank wall of the pressure tank.
